(19) United States
(12) Patent Application Publication
(10) Pub. No.: US 2026/0058483 A1
(43) Pub. Date: Feb. 26, 2026

(54) CHARGE AND DISCHARGE CONTROL CIRCUIT FOR CONTROLLING CHARGE AND DISCHARGE CONTROL SWITCH ELEMENTS

(71) Applicant: NISSHINBO MICRO DEVICES INC., Tokyo (JP)

(72) Inventor: Yuto Ii, Tokyo (JP)

(21) Appl. No.: 19/294,955

(22) Filed: Aug. 8, 2025

(30) Foreign Application Priority Data
Aug. 21, 2024 (JP) 2024-139891

(51) Int. Cl. H02J 7/00; H01M 10/44

(52) U.S. Cl. CPC H02J 7/00304; H01M 10/441; H02J 7/00306; H02J 7/0031

(57) ABSTRACT

A charge and discharge control circuit is provided for controlling a charge control switch element and a discharge control switch element, for controlling charge and discharge of a secondary battery. The charge and discharge control circuit includes: a shunt resistor for detecting a voltage corresponding to a discharge current or a charge current, and output first and second voltage potentials at first and second terminals thereof; a comparator for comparing the first voltage potential with a voltage potential of an addition voltage of a predetermined threshold voltage and the second voltage potential, and output a comparison result signal indicating an overcurrent; a logic circuit for controlling the charge or discharge control switch element based on the comparison result signal; a first LPF inserted between the first terminal of the shunt resistor and the comparator; and a second LPF inserted between the second terminal of the shunt resistor and the comparator.

### TECHNICAL FIELD

The present invention relates to a charge and discharge control circuit, a protection circuit including the charge and discharge control circuit, and a battery pack including the protection circuit.

### BACKGROUND ART

Lithium ion batteries are often used in portable devices such as smartphones and tablets. When the lithium ion battery is overcharged, the lithium ion battery may be ruptured or ignited, and when the lithium ion battery is over-discharged, there is a possibility that the lithium ion battery cannot be charged even when charged by a charger. Therefore, the battery pack has a configuration in which a protection circuit is connected to a secondary battery (see, for example, Patent Document 1). Hereinafter, the field effect transistor is referred to as an FET.

First of all, a conventional method for detecting a discharge overcurrent of a battery pack will be described below.

FIG. 1 is a circuit diagram illustrating a configuration of a battery pack according to Conventional Example 1. The battery pack of FIG. 1 includes a secondary battery B1, a charge and discharge control circuit 1, a charge control FET (CFET) 2 and a body diode 3 thereof, a discharge control FET (DFET) 4 and a body diode 5 thereof, a shunt resistor 6, a positive electrode terminal (P+) 7, and a negative electrode terminal (P−) 8. In this case, the charge control FET2 is an example of a charge control switch element, and the discharge control FET4 is an example of a discharge control switch element.

Referring to FIG. 1, a positive electrode of the secondary battery B1 is connected to a source of the charge control FET2 and an anode of the body diode 3, and a drain of the charge control FET2 and a cathode of the body diode 3 are connected to a drain of the discharge control FET4 and a cathode of the body diode 5. A source of the discharge control FET4 and an anode of the body diode 5 are connected to the positive electrode terminal (P+) 7 of the battery pack via the shunt resistor 6. On the other hand, the negative electrode of the secondary battery B1 is connected to a VSS terminal T2 of the charge and discharge control circuit 1 and the negative electrode terminal (P−) 8 of the battery pack. In this case, a VDD terminal T1 of the charge and discharge control circuit 1 is connected to the positive electrode of the secondary battery B1, the COUT terminal T11 of the charge and discharge control circuit 1 is connected to the gate of the charge control FET2, and a DOUT terminal T12 of the charge and discharge control circuit 1 is connected to the gate of the discharge control FET4. In addition, a RSENS terminal T13 of the charge and discharge control circuit 1 is connected to the source of the discharge control FET4 and one end of the shunt resistor 6, and a VP terminal T3 of the charge and discharge control circuit 1 is connected to the other end of the shunt resistor 6 and the positive electrode terminal (P+) 7 of the battery pack. It is noted that a load resistor Rload such as a CPU or a microcomputer, a charger, or both of them are connected between the positive electrode terminal (P+) 7 and the negative electrode terminal (P−) 8.

The charge and discharge control circuit 1 includes a booster circuit 9, a logic circuit 10, a comparator 11, a constant current source 13, a resistor 12, and the six terminals T1 to T3 and T11 to T13. A power supply voltage VDD input to the VDD terminal T1 is input to the booster circuit 9, and the booster circuit 9 boosts the power supply voltage VDD and outputs the boosted voltage VCP to the logic circuit 10. The detection voltage potential v2 detected at the VP terminal T3 is applied to the inverting input terminal of the comparator 11. The voltage detected at the RSENS terminal T13 is applied as a voltage potential v1 to the non-inverting input terminal of the comparator 11 via one end and the other end of the resistor 12. The other end of the resistor 12 is grounded via the constant current source 13.

The comparator 11 compares the input voltage potential v2 with the input voltage potential v1 and outputs a comparison result signal Sout to the logic circuit 10. Based on the boosted voltage VCP and the comparison result signal Sout, the logic circuit 10 generates the charge control gate control signal Sc and the discharge control gate control signal Sd and outputs the charge control gate control signal Sc and the discharge control gate control signal Sd to the gate of the charge control FET2 and the gate of the discharge control FET4 via the COUT terminal T11 and the DOUT terminal T12, respectively, as described in detail below.

FIG. 2 is an example of a circuit diagram illustrating a configuration of the booster circuit 9 of FIG. 1, and FIG. 3 is an example of a circuit diagram illustrating a configuration of the comparator 11 of FIG. 1. Referring to FIG. 2, the booster circuit 9 includes a control circuit 9a, transistor switches 8a, 8b, 8c, and 8d, and a capacitor C1. The comparator 11 includes N-channel MOSFETs (NMOSFET) 11a and 11b, P-channel MOSFETs (PMOSFET) 17a and 17b, and a constant current source 16.

First of all, a circuit operation at the time of discharge of the charge and discharge control circuit 1 of FIG. 1 will be described below.

During discharging, a load resistor Rload such as a CPU or a microcomputer is connected between the positive electrode terminal (P+) 7 and the negative electrode terminal (P−) 8. The discharge current from the positive electrode of the secondary battery B1 flows to the load resistor Rload via the charge control FET2, the discharge control FET4, the shunt resistor 6, and the positive electrode terminal (P+) 7, and further flows to the negative electrode of the secondary battery B1 via the negative electrode terminal (P−) 8. When the discharge current flows, the charge and discharge control circuit 1 monitors a voltage potential difference (I×R6=Vrsens−Vvp) between the voltage potential Vrsens of the RSENS terminal T13 and the voltage potential Vvp of the VP terminal T3, which is generated by the discharge current I and the shunt resistor 6 (resistance value R6). In this case, when the voltage potential Vvp of the VP terminal T3 is lower than the voltage potential Vrsens of the RSENS terminal T13 by a predetermined threshold voltage Vth, that is, when v2<Vrsens−Vth=v1, the discharge overcurrent is detected. When the discharge overcurrent is detected, the comparator 11 outputs an H-level comparison result signal Sout to the logic circuit 10. In response to this, the logic circuit 10 outputs an L-level gate control signal Sd to the gate of the discharge control FET4 to turn off the discharge control FET4 and stop the discharge current of the secondary battery B1. Specifically, the detection voltage potential v1 (v1=Vrsens−Vth, Vth=R12×I13) is generated using the resistor 12 (resistance value R12) and the constant current source 13 (current value I13) based on the voltage potential Vrsens of the RSENS terminal T13. The comparator 11 compares the detection voltage potential v1 with the detection voltage potential v2 (v2=Vvp) of the VP terminal T3. It is noted that, since the predetermined threshold voltage Vth is generated by the resistor 12 and the constant current source 13, the predetermined threshold voltage Vth may be generated by a constant voltage source.

At the time of a normal discharge current, v1<v2 is satisfied, and the comparator 11 outputs an L level (VSS) comparison result signal Sout to the logic circuit 10. In response to this, the logic circuit 10 generates the H-level VCP (for example, VDD×2) generated by the booster circuit 9 illustrated in FIG. 2 as the gate control signal Sd, applies the gate control signal Sd to the gate of the discharge control FET4 to turn on the discharge control FET4, and causes the discharge current to flow.

In addition, according to a predetermined clock, the control circuit 9a of the booster circuit 9 controls the operation of the booster circuit 9 so as to repeat:
(1) the operation of turning on the switch 8a in FIG. 2, turning off the switch 8b, turning off the switch 8c, and turning on the switch 8d to charge the capacitor C1 with the charge of the voltage difference between the output voltage VDD and the ground voltage VSS; and
(2) the operation of turning off the switch 8a in FIG. 2, turning on the switch 8b, turning on the switch 8c, and turning off the switch 8d to generate the boosted voltage VCP (for example, VDD×2) and output the generated boosted voltage VCP to the logic circuit 10.

At the time of abnormal discharge current (discharge overcurrent), v1>v2 is satisfied, and as described above, the comparator 11 outputs the H level (VDD) comparison result signal Sout to the logic circuit 10. In response to this, the logic circuit 10 applies the gate control signal Sd at the L level (VSS) to the gate of the discharge control FET4 to turn off the discharge control FET4, thereby stopping the abnormal discharge current (discharge overcurrent).

### PRIOR ART DOCUMENT

### Patent Document

Patent Document 1: Japanese Patent No. JP5338047B2

### SUMMARY OF THE DISCLOSURE

### Problems to be Solved by the Disclosure

In the configuration of the battery pack including the protection circuit according to Conventional Example 1 as described above, for example, there is a problem that high-frequency noise of about 1 GHz or more is applied to a terminal (VSS terminal T2, VP terminal T3, RSENS terminal T13) or a circuit for detecting a discharge overcurrent, so that the protection circuit is erroneously detected and malfunctions.

An object of the present invention is to solve the above problems, and to provide a charge and discharge control circuit capable of avoiding erroneous detection or erroneous operation and capable of detecting a discharge overcurrent even when high-frequency noise of, for example, about 1 GHz or more is applied to a terminal or a circuit for detecting a discharge overcurrent, a protection circuit including the charge and discharge control circuit, and a battery pack including the protection circuit.

### Solutions to the Problems

According to one aspect of the disclosure, there is provided a charge and discharge control circuit configured to control a charge control switch element and a discharge control switch element. The charge control switch element is configured to control charge of a secondary battery, and the discharge control switch element is connected in series with the charge control switch element, and is configured to control discharge of the secondary battery. The charge and discharge control circuit includes: a shunt resistor that is connected in series with the charge control switch element or the discharge control switch element and is connected between the secondary battery and a load, and is configured to detect a voltage corresponding to a discharge current or a charge current, and output first and second voltage potentials at a first terminal and a second terminal of the shunt resistor; a comparator configured to compare the first voltage potential with a voltage potential of an addition voltage obtained by adding a predetermined threshold voltage to the second voltage potential, and output a comparison result signal indicating an overcurrent; a logic circuit configured to control the charge control switch element or the discharge control switch element based on the comparison result signal; a first low-pass filter inserted between the first terminal of the shunt resistor and the comparator; and a second low-pass filter inserted between the second terminal of the shunt resistor and the comparator.

### Effects of the Disclosure

Therefore, according to the charge and discharge control circuit of the present invention, since the low-pass filter is inserted into the circuit of the detection voltage of the charge and discharge control circuit, even if high-frequency noise is applied to the terminal or the circuit that detects the discharge overcurrent, the noise can be attenuated, so that it is possible to detect erroneous detection or erroneous operation of the protection circuit of the battery pack, and it is possible to detect and stop the discharge overcurrent.

### BRIEF DESCRIPTION OF DRAWINGS

FIG. 1 is a circuit diagram illustrating a configuration of a battery pack according to Conventional Example 1;

FIG. 2 is a circuit diagram illustrating a configuration of a booster circuit 9 in FIG. 1;

FIG. 3 is a circuit diagram illustrating a configuration of a comparator 11 in FIG. 1;

FIG. 4A is a circuit diagram illustrating a configuration example of a battery pack according to a first embodiment;

FIG. 4B is a circuit diagram illustrating a configuration example of a battery pack according to a modified embodiment of the first embodiment;

FIG. 5 is a circuit diagram illustrating a configuration example of a battery pack according to a second embodiment;

FIG. 6 is a circuit diagram illustrating a configuration example of a battery pack according to a third embodiment;

FIG. 7 is a circuit diagram illustrating a configuration example of a battery pack according to a fourth embodiment;

FIG. 8 is a circuit diagram illustrating a configuration of a battery pack according to Conventional Example 2;

FIG. 9 is a circuit diagram illustrating a configuration example of a battery pack according to a fifth embodiment;

FIG. 10 is a circuit diagram illustrating a configuration example of a battery pack according to a sixth embodiment; and

FIG. 11 is a circuit diagram illustrating a configuration example of a battery pack according to a seventh embodiment.

### DETAILED DESCRIPTIONS

Hereinafter, embodiments and modified embodiments according to the present invention will be described with reference to the drawings. It is noted that the same or similar components are denoted by the same reference numerals.

### FINDINGS OF INVENTORS

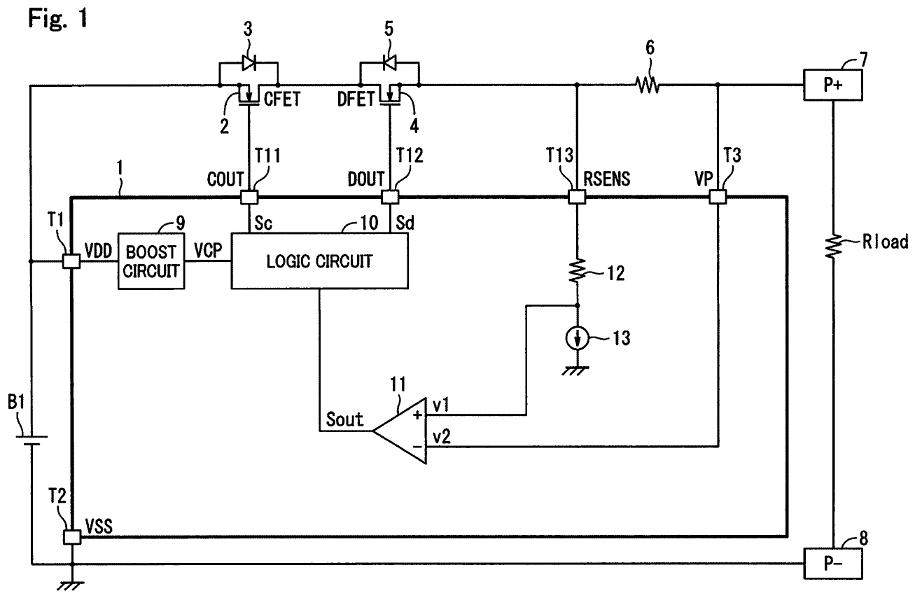

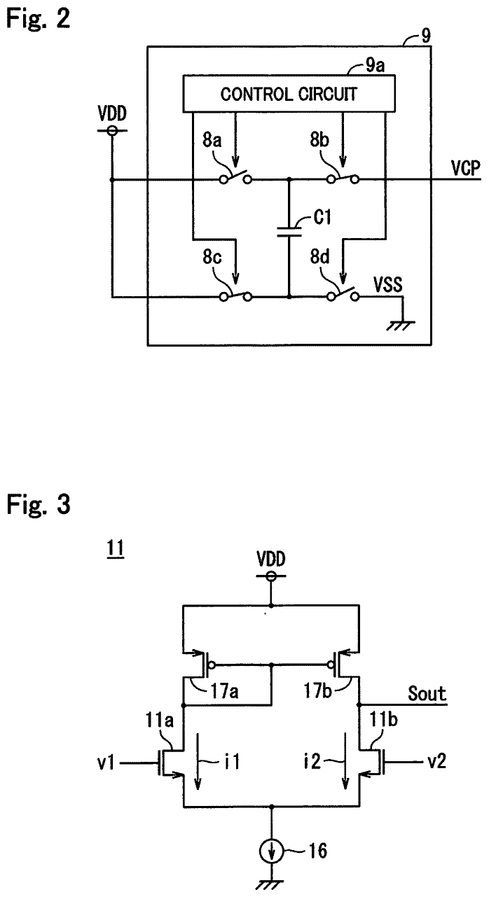

First of all, a mechanism of erroneous detection in a protection circuit will be described below with reference to FIGS. 1 to 3 described above.

For example, it is assumed that high-frequency noise of 1 GHz or more generated by irradiation of radio waves of a high frequency of 1 GHz or more or operation of a system (load resistance Rload in FIG. 1) connected between the positive electrode terminal 7 and the negative electrode terminal 8 for other reasons propagates to the RSENS terminal T13 and the VP terminal T3. At this time, the noise amplitude of the voltage potential v1 input to the non-inverting input terminal of the comparator 11 is attenuated to some extent by a low-pass filter including the resistor 12 and an input capacitor (not illustrated) of the comparator 11. On the other hand, since the voltage potential v2 input to the inverting input terminal of the comparator 11 is directly connected from the VP terminal T3 to the inverting input terminal of the comparator 11, the noise amplitude is not attenuated.

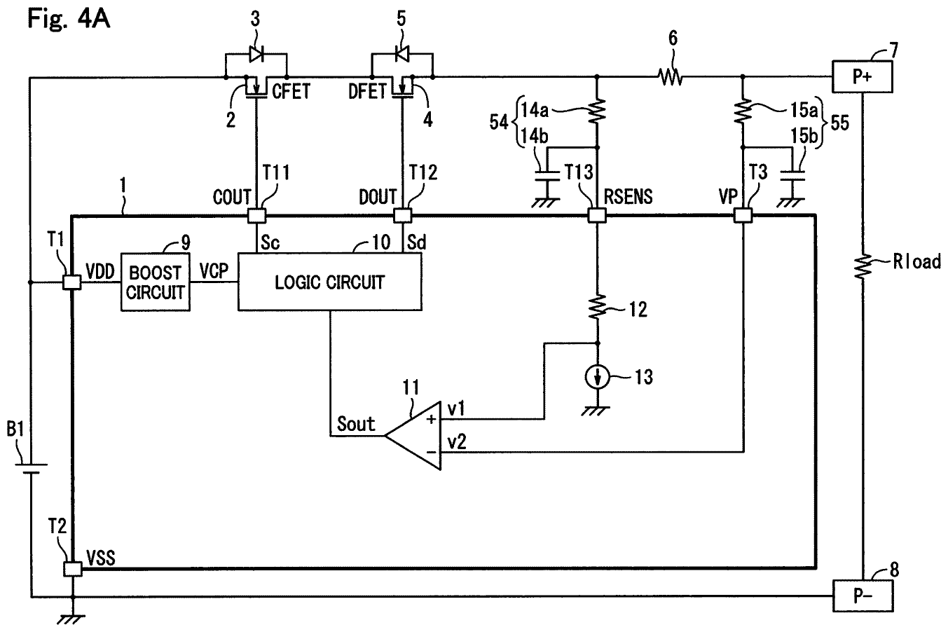

The comparator 11 of FIG. 3 includes a current mirror circuit including two PMOSFETs 17a and 17b, two NMOSFETs 11a and 11b, and a constant current source 16. A power supply voltage VDD, which is an input voltage, is applied to the sources of the two PMOSFETs 17a and 17b. In addition, the gates of the PMOSFETs 17a and 17b are connected to each other, and the gate and the drain of the PMOSFET 17a are also connected to each other. Further, the drains of the two PMOSFETs 17a and 17b are connected to the drains of the two NMOSFETs 11a and 11b, respectively, and the sources of the two NMOSFETs 11a and 11b are grounded via the constant current source 16.

In the comparator 11 configured as described above, the gates of the two NMOSFETs 11a and 11b have the voltage potential v1 at the non-inverting input terminal and the voltage potential v2 at the inverting input terminal, respectively. In this case, as illustrated in FIG. 3, the current flowing through the channel of the NMOSFET 11a is defined as a current i1, and the current flowing through the channel of the NMOSFET 11b is defined as a current i2. In this case, in a case where the amplitude of the noise propagating to the latter voltage potential v2 is larger than the noise propagating to the former voltage potential v1, since i1<i2 is satisfied due to nonlinearity of a general transistor, the comparison result signal Sout of the comparator 11 is forcibly fixed to the L level (the level when no overcurrent is detected). When the comparison result signal Sout is fixed to the L level, the gate control signal Sd of the logic circuit 10 is fixed to the H level, so that the discharge control FET4 continues to be turned on.

As a result, when a radio wave having a high frequency of, for example, 1 GHz or more is emitted, or when a high-frequency noise having a high frequency of, for example, 1 GHz or more propagates to the RSENS terminal T13 and the VP terminal T3, there arises such a problem that a current abnormality cannot be detected (that is, the discharge overcurrent cannot be detected) even if an abnormal discharge current flows. This embodiment is provided to solve this problem.

### FIRST EMBODIMENT

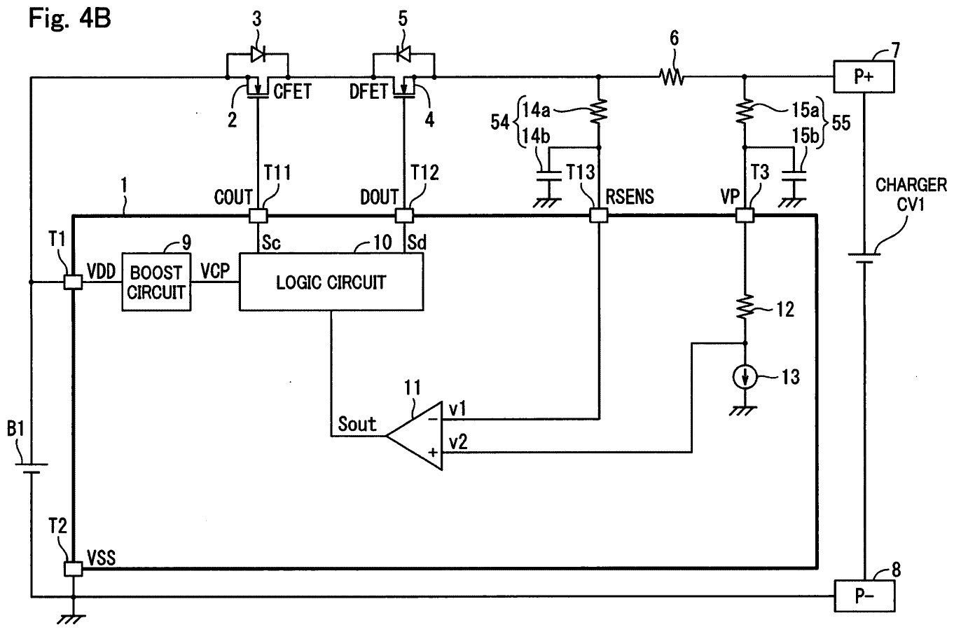

FIG. 4A is a circuit diagram illustrating a configuration example of a battery pack according to a first embodiment. The battery pack of FIG. 4A is different from the battery pack of FIG. 1 in the following points.
(1) A low-pass filter 54 including a resistor 14a and a capacitor 14b is inserted between one end of a shunt resistor 6 and a RSENS terminal T13.
(2) A low-pass filter 55 including a resistor 15a and a capacitor 15b is inserted between the other end of the shunt resistor 6 and the VP terminal T3.
(3) In this case, the low-pass filters 54 and 55 are inserted outside a charge and discharge control circuit 1, but may be inserted inside the charge and discharge control circuit 1, or the charge and discharge control circuit 1 may include the low-pass filters 54 and 55.

Referring to FIG. 4A, the entire circuit of FIG. 4A including a secondary battery B1 and excluding a resistive load Rload is a battery pack, and a circuit obtained by removing a charge control FET2 and a discharge control FET4 from the battery pack may be referred to as a charge and discharge control circuit, and a circuit obtained by removing the charge control FET2 and the discharge control FET4 and the low-pass filters 54 and 55 from the battery pack may be referred to as a charge and discharge control circuit.

In the battery pack of FIG. 4A configured as described above, by providing the low-pass filters 54 and 55, it is possible to attenuate the amplitude of noise propagating from the RSENS terminal T13 to a voltage potential v1 of the non-inverting input terminal of the comparator 11 and from the VP terminal T3 to a voltage potential v2 of the inverting input terminal of the comparator 11. As a result, it is possible to avoid noise from propagating to the gates (FIG. 3) of differential pair NMOSFET 11a and NMOSFET 11b of the comparator 11. As a result, it is possible to solve such a problem that an output signal Sout of the comparator 11 is fixed to the L level due to the influence of noise generated in the conventional configuration.

FIG. 4B is a circuit diagram illustrating a configuration example of a battery pack according to a modified embodiment of the first embodiment. The battery pack of FIG. 4B is different from the battery pack of FIG. 4A in the following points.
(1) The circuit of the resistor 12 and the constant current source 13 in the charge and discharge control circuit 1 is moved and inserted into the circuit between the VP terminal T3 and the inverting input terminal of the comparator 11.
(2) A charger CV1 is provided instead of the resistive load Rload.
The battery pack of FIG. 4B configured as described above has the same function and effect as the battery pack of FIG. 4A.

### SECOND EMBODIMENT

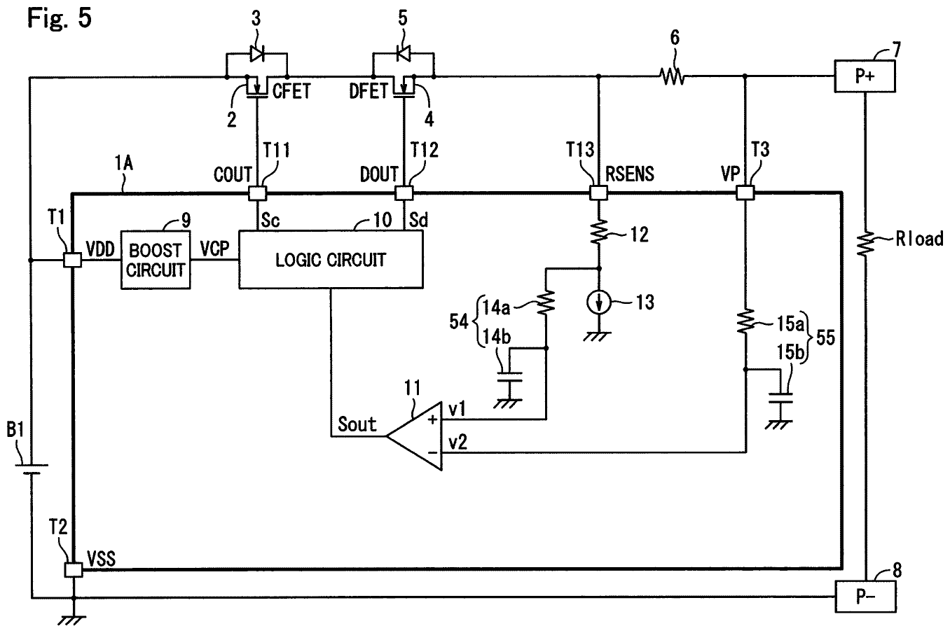

FIG. 5 is a circuit diagram illustrating a configuration example of a battery pack according to a second embodiment. The battery pack of FIG. 5 is different from the battery pack of FIG. 4A in the following points.
(1) The charge and discharge control circuit 1 is replaced with a charge and discharge control circuit 1A and configured as follows.
(2) The low-pass filter 54 is moved and inserted between the resistor 12 and the non-inverting input terminal of the comparator 11.
(3) The low-pass filter 55 is moved and inserted between the VP terminal T3 and the inverting input terminal of the comparator 11.

The battery pack of FIG. 5 configured as described above has the same function and effect as the battery pack of FIGS. 4A and 4B.

### THIRD EMBODIMENT

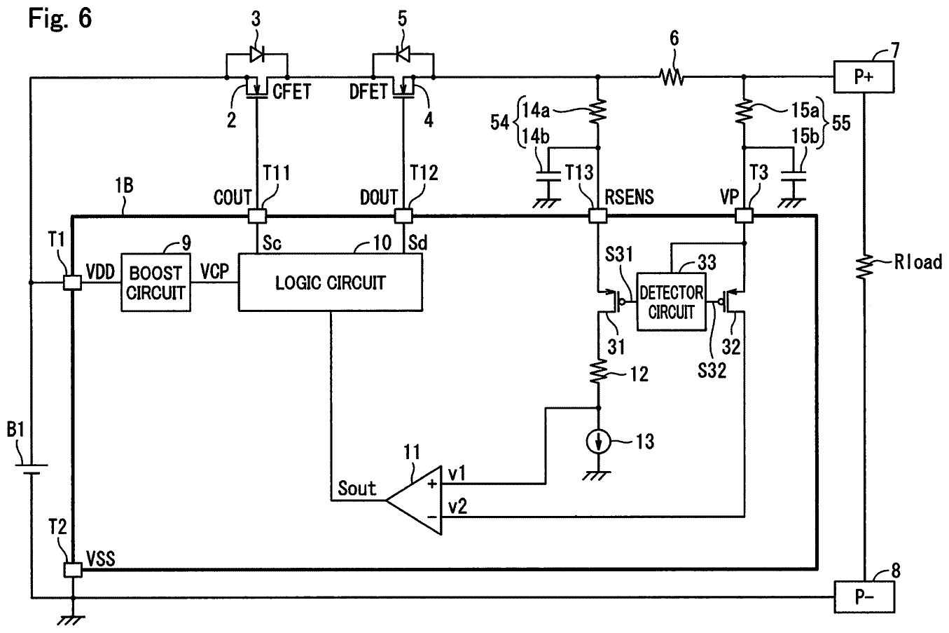

FIG. 6 is a circuit diagram illustrating a configuration example of a battery pack according to a third embodiment. The battery pack of FIG. 6 is different from the battery pack of FIG. 4A in the following points.
(1) The charge and discharge control circuit 1 is replaced with a charge and discharge control circuit 1B and configured as follows.
(2) PMOSFETs 31 and 32 used as transistor switches and a detector circuit 33 are inserted into the circuit between the RSENS terminal T13 and the resistor 12 and the circuit between the VP terminal T3 and the inverting input terminal of the comparator 11.
The differences will be described below.

When the secondary battery B1 is charged, the resistance load Rload, which is, for example, a charger, is connected between the positive electrode terminal 7 and the negative electrode terminal 8. It is assumed that a charger connected to the positive electrode terminal 7 outputs a high voltage due to some failure. Therefore, the elements connected to the RSENS terminal T13 and the VP terminal T3 need to be configured with high withstand voltage elements in order not to be broken even when a high voltage is applied, but there are disadvantages in cost and construction period such as an increase in circuit area of LSI, an increase in the number of masks used in a semiconductor manufacturing process, and an increase in lead time. Therefore, when the voltage of the positive electrode terminal 7 exceeds a predetermined threshold voltage (for example, VDD+1 V), the detector circuit 33 outputs H-level gate control signals S31 and S32 to the gates of the PMOSFETs 31 and 32, respectively, to turn off the PMOSFETs 31 and 32. As a result, it is possible to prevent a high voltage from the charger connected to the positive electrode terminal 7 from being applied to the resistor 12, the constant current source 13, and the comparator 11, and thus, it is possible to configure the resistor 12, the constant current source 13, and the comparator 11 with low withstand voltage elements. Therefore, it is possible to obtain advantages of area saving of the LSI circuit, reduction of the number of masks used in the semiconductor manufacturing process, and shortening of the lead time.

In addition, for example, it is assumed that high-frequency noise of 1 GHz or more generated by irradiation of radio waves of a high frequency of 1 GHz or more or operation of a system (load resistance such as a CPU) connected between the positive electrode terminal 7 and the negative electrode terminal 8 propagates to the RSENS terminal T13 and the VP terminal T3. When noise is propagated to the RSENS terminal T13 and the VP terminal T3, the PMOSFETs 31 and 32 are turned off due to nonlinearity of the transistor. In this case, the nonlinearity of the transistor means that Vgs of the transistor is opened or closed according to noise, but in a case where the amplitude is large, the off-section is longer than the on-section, and the current value becomes larger than the off-section in terms of time average.

In this case, when the PMOSFETs 31 and 32 are turned off, the DC voltage of the non-inverting input terminal of the comparator 11 is pulled down to the ground voltage VSS by the constant current source 13. On the other hand, no pull-down circuit is connected to the inverting input terminal of the comparator 11. Therefore, the magnitude relationship of the DC voltage of each input terminal of the comparator 11 is v1<v2, and an output signal Sout of the comparator 11 is fixed to the L level. As a result, even if an abnormal discharge current flows when noise is emitted, there is a problem that an abnormality (discharge overcurrent) of the discharge current cannot be detected.

In order to solve this problem, low-pass filters 54 and 55 are provided in the RSENS terminal T13 and the VP terminal T3, respectively, so that the amplitude of the noise propagating to the PMOSFETs 31 and 32 can be attenuated.

Further, in a case where the charger connected between the positive electrode terminal 7 and the negative electrode terminal 8 rapidly outputs a high voltage due to some failure, there is a possibility that a high voltage is instantaneously applied to the resistor 12, the constant current source 13, and the comparator 11 until the detector circuit 33 detects a high voltage of the charger voltage and turns off the PMOSFETs 31 and 32. However, the low-pass filters 54 and 55 can blunt a change in voltage rise of the RSENS terminal T13 and the VP terminal T3, and it is possible to prevent a high voltage from being instantaneously applied to the resistor 12, the constant current source 13, and the comparator 11.

It is noted that the PMOSFETs 31 and 32, which are transistor switches, may be NMOSFETs, and the detector circuit 33 may be configured to output the H-level gate control signals S31 and S32 when the charger voltage exceeds a predetermined threshold. In addition, each of the resistor 12 and the constant current source 13 may be a constant voltage source. In addition, the circuit including the detector circuit 33 can also be applied to a charging overcurrent detector circuit.

As described above, according to the present embodiment, since the amplitude of the noise propagating to the PMOSFETs 31 and 32 is attenuated by the low-pass filters 54 and 55, it is possible to avoid turning off due to the nonlinearity of the PMOSFETs 31 and 32 and to prevent the comparison result signal Sout of the comparator 11 from being fixed to the H level or the L level. Therefore, the discharge overcurrent can be detected even when noise is propagating. In addition, the resistor 12, the constant current source 13, and the comparator 11 can be configured by low withstand voltage elements. Therefore, it is possible to obtain advantages of area saving of the LSI circuit, reduction of the number of masks used in the semiconductor manufacturing process, and shortening of the lead time.

### FOURTH EMBODIMENT

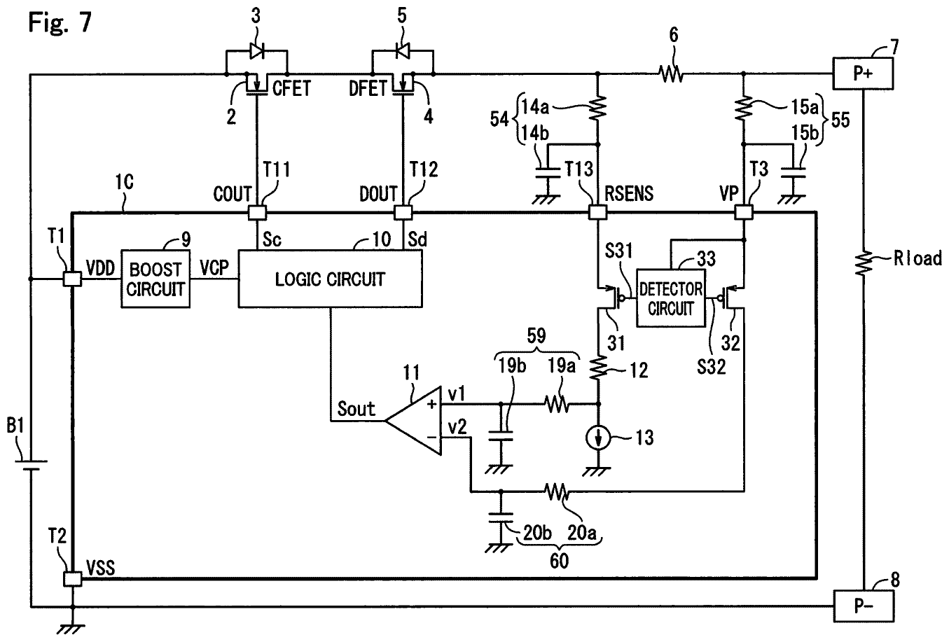

FIG. 7 is a circuit diagram illustrating a configuration example of a battery pack according to a fourth embodiment. The battery pack of FIG. 7 is different from the battery pack of FIG. 6 in the following points.
(1) The charge and discharge control circuit 1B is replaced with a charge and discharge control circuit 1C and configured as follows.
(2) A low-pass filter 59 including a resistor 19a and a capacitor 19b is inserted between the other end of the resistor 12 and the non-inverting input terminal of the comparator 11.
(3) A low-pass filter 60 including a resistor 20a and a capacitor 20b is inserted between the drain of the PMOSFET 32 and the inverting input terminal of the comparator 11.
Differences Will Be Described Below.

In a case where the high frequency noise that is not attenuated in the low-pass filters 54 and 55 of FIG. 6 propagates to the RSENS terminal T13 and the VP terminal T3, it is conceivable that the noise propagates to each input terminal of the comparator 11 via the PMOSFETs 31 and 32 which are transistor switches, or it is conceivable that the noise applied on the secondary battery B1 side of the low-pass filter 54 propagates to each input terminal of the comparator 11. In a manner similar to that of the battery pack of FIG. 4, the comparison result signal Sout of the comparator 11 is fixed to the L level due to the nonlinearity of the differential pair transistors of the comparator 11, and such a problem that the discharge overcurrent cannot be detected occurs. In the present embodiment, the low-pass filters 59 and 60 are provided immediately before the respective input terminals of the comparator 11, so that the amplitude of the noise propagating to the respective input terminals of the comparator 11 can be attenuated.

As described above, according to the present embodiment, by providing the low-pass filters 59 and 60 immediately before the input terminals of the comparator 11, respectively, it is possible to cut noise of a frequency that is not attenuated by the low-pass filters 54 and 55 and to avoid propagation of noise to the comparator 11. Therefore, even if high-frequency noise of, for example, 1 GHz or more propagates to the RSENS terminal T13 and the VP terminal T3, it is possible to normally perform discharge overcurrent detection, and by connecting the external low-pass filters 54 and 55 and the low-pass filters 59 and 60 in the charge and discharge control circuit 1C, it is possible to deal with various noise propagation by removing noise in different frequency bands, attenuating noise in a specific frequency band, and removing radio wave noise immediately before the terminal of the charge and discharge control circuit or received in the charge and discharge control circuit.

It is noted that the threshold values created by the resistor 12 and the constant current source 13 may be replaced with a predetermined constant voltage source. In addition, the present embodiment can also be applied to a charging overcurrent detector circuit.

### CONVENTIONAL EXAMPLE 2

Conventional Example 2 for describing fifth to eighth embodiments will be described below.

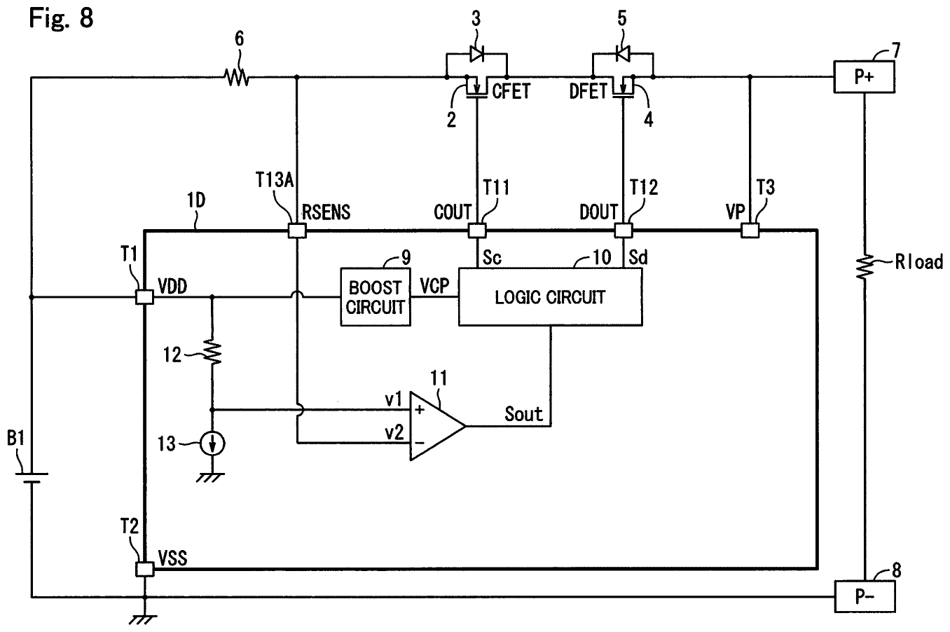

FIG. 8 is a circuit diagram illustrating a configuration of a battery pack according to Conventional Example 2. The battery pack of FIG. 8 is different from the battery pack of FIG. 1 in the following points.
(1) The charge and discharge control circuit 1 is replaced with a charge and discharge control circuit 1D and configured as follows.
(2) The RSENS terminal T13 is moved to become a RSENS terminal T13A.
(3) The shunt resistor 6 is inserted between the anode terminal of the secondary battery B1 and the charge control FET2, one end of the shunt resistor 6 is connected to the anode terminal of the secondary battery B1, and the other end of the shunt resistor 6 is connected to the RSENS terminal T13A.
(4) The circuit of the resistor 12 and the constant current source 13 in the charge and discharge control circuit 1 is moved and inserted into a circuit between the VDD terminal T1 and the input terminal of the booster circuit 9.
The differences will be described below.

Referring to FIG. 8, the RSENS terminal T13A is connected to the inverting input terminal (voltage potential v2) of the comparator 11, and v2=Vrsens. In addition, the resistor 12 that generates a predetermined threshold voltage Vth and a voltage generation circuit of the constant current source 13 are connected to the VDD terminal T1, and the voltage potential v1 of the voltage generation circuit is applied to the non-inverting input terminal (voltage potential v1=VDD−Vth) of the comparator 11. In addition, the shunt resistor 6 performs overcurrent abnormality detection (discharge overcurrent detection) from a voltage potential difference (Vvdd-Vrsens) between the voltage VDD at the VDD terminal T1 and the voltage potential Vrsens at the RSENS terminal T13A. In this case, the current I flowing through the shunt resistor 6 is expressed by the following equation:

I=(vvdd−Vrsens)/r6).

In a case where the RSENS terminal T13A is on the positive electrode terminal 7 side as illustrated in FIG. 1, a charger that has failed for some reason may output a high voltage, and thus a circuit connected to the RSENS terminal T13 needs to be an element having a high withstand voltage. On the other hand, as illustrated in FIG. 8, when the RSENS terminal T13A is disposed on the secondary battery B1 side, the voltage of the secondary battery B1 is applied to the RSENS terminal T13A, so that a higher voltage is not applied as much as the charger. Therefore, a low withstand voltage element can be used for the circuit connected to the RSENS terminal T13A, and advantages of area saving of the LSI circuit, reduction of the number of masks used in the semiconductor manufacturing process, and reduction of the lead time can be obtained.

In the configuration of FIG. 8 configured as described above, when the secondary battery B1 is irradiated with radio waves of high frequency at the time of discharge, or when noise is generated by a system (which is of a CPU or a microcomputer corresponding to the load resistance Rload in FIG. 8) connected between the positive electrode terminal 7 and the negative electrode terminal 8, the noise propagates to the RSENS terminal T13A and the VDD terminal T1 via a discharge control FET4 and the charge control FET2. It is noted that, in this case, it is assumed that noise (for example, sine wave) propagating to the positive electrode terminal 7 via the charge control FET2 and the discharge control FET4 propagates to the VDD terminal T1 as it is.

Also in the present conventional example, in a manner similar to that of Conventional Example 1 in FIG. 1, the comparison result signal Sout of the comparator 11 is fixed to the L level (non-detection), and there arises a similar problem that the discharge overcurrent cannot be detected even when an abnormal discharge current is generated. In order to solve this problem, fifth to seventh embodiments are proposed.

### FIFTH EMBODIMENT

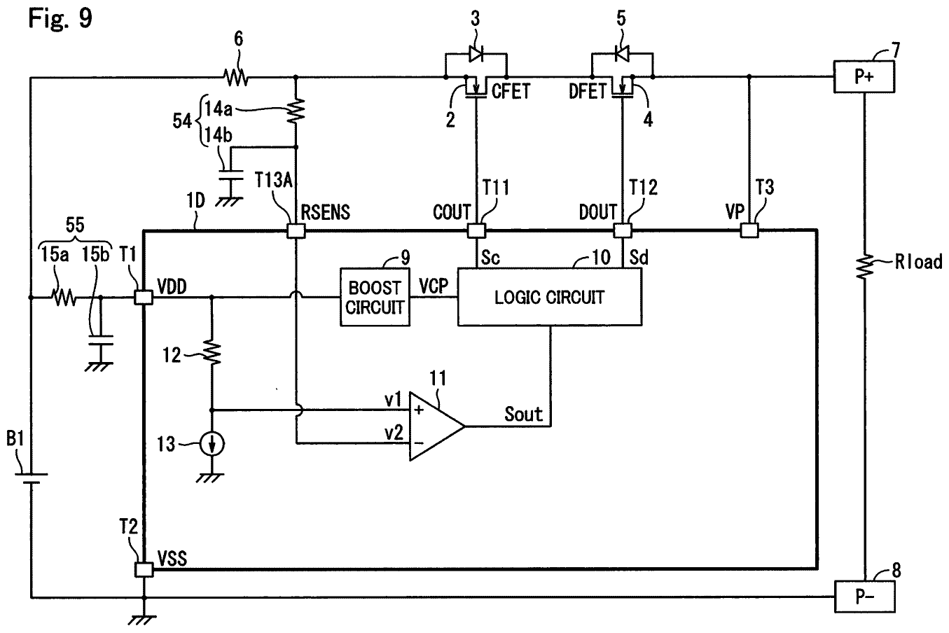

FIG. 9 is a circuit diagram illustrating a configuration example of a battery pack according to a fifth embodiment. The battery pack of FIG. 9 is different from the battery pack of FIG. 8 in the following points.
(1) A low-pass filter 54 including a resistor 14a and a capacitor 14b is inserted between the other end of the shunt resistor 6 and the RSENS terminal T13A.
(2) A low-pass filter 55 including a resistor 15a and a capacitor 15b is inserted between one end of the shunt resistor 6 and the VDD terminal T1.

According to the fifth embodiment configured as described above, the problem of Conventional Example 2 in FIG. 8 can be solved by providing the low-pass filters 54 and 55. It is noted that, in FIG. 9, the constant voltage source may generate a threshold voltage generated by a resistor 12 and a constant current source 13. In addition, the fifth embodiment can also be applied to a charging overcurrent detector circuit.

### SIXTH EMBODIMENT

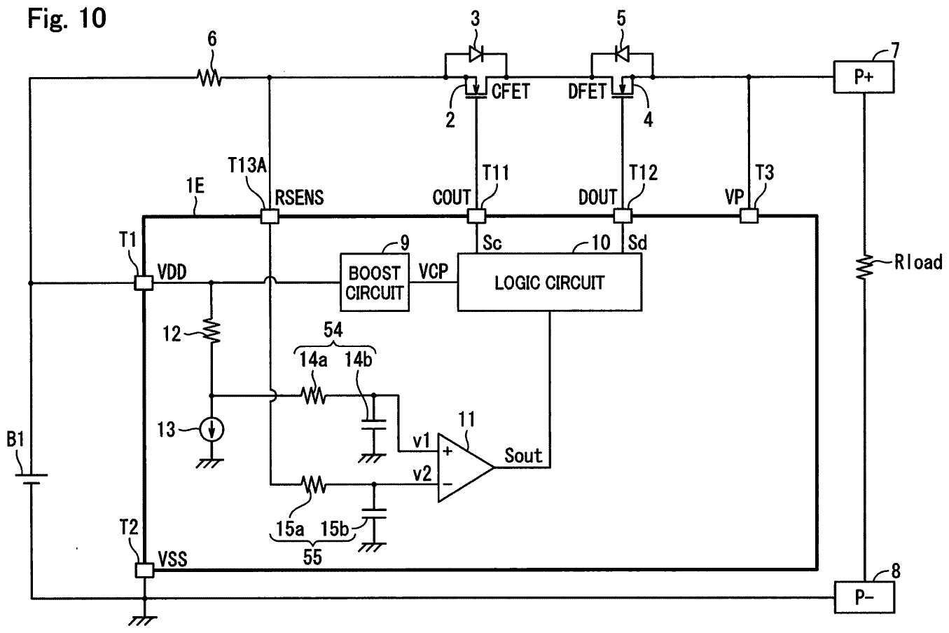

FIG. 10 is a circuit diagram illustrating a configuration example of a battery pack according to a sixth embodiment. The battery pack of FIG. 10 is different from the battery pack of FIG. 9 in the following points.
(1) The charge and discharge control circuit 1D is replaced with a charge and discharge control circuit 1E and configured as follows.
(2) The low-pass filter 54 is moved and inserted between the other end of the resistor 12 and the non-inverting input terminal of the comparator 11.
(3) The low-pass filter 55 is moved and inserted between the RSENS terminal T13A and the inverting input terminal of the comparator 11.

In this case, specific problems in the battery pack of FIG. 9 will be described below. In the configuration of FIG. 9, the voltage drop by the constant current source 13 and the resistor 15a affects a voltage potential v1 of the non-inverting input terminal of the comparator 11, and the voltage potential v1 decreases. In addition, since the currents by the resistor 15a and the constant current source 13 vary depending on the manufacturing process, the voltage drop by the constant current source 13 and the resistor 15a varies and affects the voltage potential v1 of the non-inverting input terminal of the comparator 11, and the voltage potential v1 varies. As a result, there is such a problem that the detection accuracy of the overcurrent is deteriorated as compared with the configuration of FIG. 8 according to Conventional Example 2, and the configuration of the sixth embodiment has been proposed in order to solve this problem.

According to the sixth embodiment configured as described above, by providing the low-pass filters 54 and 55 immediately before the respective input terminals of the comparator 11, it is possible to avoid erroneous detection due to noise and to solve the problem of deterioration of the detection accuracy in FIG. 9 in a manner similar to that of FIG. 4A. That is, by connecting the low-pass filters 54 and 55 in the charge and discharge control circuit 1E to remove radio wave noise received by the charge and discharge control circuit 1E, it is possible to avoid propagation of noise to the gates (FIG. 3) of differential pair NMOSFET 11a and NMOSFET 11b of the comparator 11. It is noted that the threshold voltage generated by the resistor 12 and the constant current source 13 may be generated by a constant voltage source. In addition, the sixth embodiment can also be applied to a charging overcurrent detector circuit.

### SEVENTH EMBODIMENT

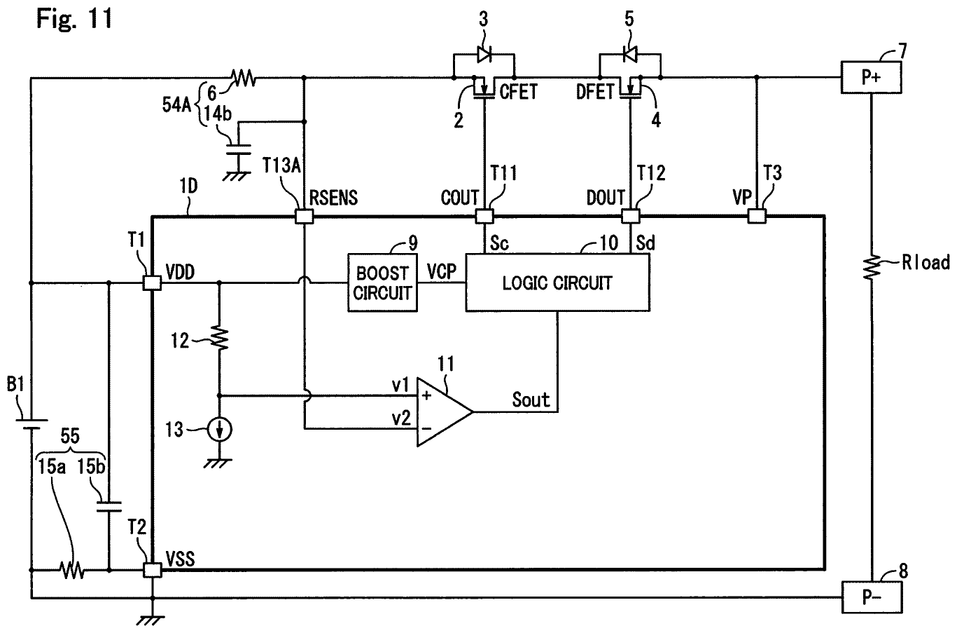

FIG. 11 is a circuit diagram illustrating a configuration example of a battery pack according to a seventh embodiment. The battery pack of FIG. 11 is different from the battery pack of FIG. 9 in the following points.
(1) A low-pass filter 55 is inserted between the secondary battery B1 and the VSS terminal T2.
(2) The shunt resistor 6 and the capacitor 14b configure a low-pass filter 54A.
The differences will be described below.

Referring to FIG. 11, the resistor 15a of the low-pass filter 55 is connected between the negative electrode terminal of the secondary battery B1 and the VSS terminal T2, and the capacitor 15b is connected between the VSS terminal T2 and the VDD terminal T1.

According to the seventh embodiment configured as described above, noise propagating to the VDD terminal T1 and the RSENS terminal T13A can be attenuated, and erroneous detection of the comparator 11 can be solved. In addition, it is possible to solve the problem of the accuracy degradation of the discharge overcurrent detection due to the variation in the voltage potential v1 due to the voltage drop due to a manufacturing variation of a constant current source 13 and the resistor 15a of the VDD terminal T1, which is the specific problem in FIG. 9. It is noted that the threshold voltage generated by the resistor 12 and the constant current source 13 may be generated by a constant voltage source. In addition, the seventh embodiment can also be applied to a charging overcurrent detector circuit.

### INDUSTRIAL APPLICABILITY

Therefore, according to the charge and discharge control circuit of the present invention, since the low-pass filter is inserted into the circuit of the detection voltage of the charge and discharge control circuit, even if high-frequency noise is applied to the terminal or the circuit that detects the discharge overcurrent, the noise can be attenuated, so that it is possible to detect erroneous detection or erroneous operation of the protection circuit of the battery pack, and it is possible to detect and stop the discharge overcurrent.

What is claimed is

1. A charge and discharge control circuit configured to control a charge control switch element and a discharge control switch element,
wherein the charge control switch element is configured to control charge of a secondary battery,
wherein the discharge control switch element is connected in series with the charge control switch element, and is configured to control discharge of the secondary battery,
wherein the charge and discharge control circuit comprises:
a shunt resistor that is connected in series with the charge control switch element or the discharge control switch element and is connected between the secondary battery and a load, and is configured to detect a voltage corresponding to a discharge current or a charge current, and output first and second voltage potentials at a first terminal a nd a second terminal of the shunt resistor;
a comparator configured to compare the first voltage potential with a voltage potential of an addition voltage obtained by adding a predetermined threshold voltage to the second voltage potential, and output a comparison result signal indicating an overcurrent;
a logic circuit configured to control the charge control switch element or the discharge control switch element based on the comparison result signal;
a first low-pass filter inserted between the first terminal of the shunt resistor and the comparator; and
a second low-pass filter inserted between the second terminal of the shunt resistor and the comparator.

2. The charge and discharge control circuit as claimed in claim 1,
wherein the first and second low-pass filters are provided as an inner circuit or an outer circuit of the charge and discharge control circuit.

3. The charge and discharge control circuit as claimed in claim 1,
wherein the first and second low-pass filters are provided as an inner circuit of the charge and discharge control circuit, and are directly connected to respective input terminals of the comparator.

4. The charge and discharge control circuit as claimed in claim 1, further comprising:
a detector circuit that is connected to the first terminal or the second terminal of the shunt resistor and is configured to detect that a predetermined high voltage is applied to the shunt resistor; and
a switch element configured to disconnect a circuit between the shunt resistor and the comparator when the detector circuit detects that the predetermined high voltage is applied.

5. The charge and discharge control circuit as claimed in claim 1, further comprising:
a detector circuit that is connected to the first terminal or the second terminal of the shunt resistor and is configured to detect that a predetermined high voltage is applied to the shunt resistor;
first and second switch elements configured to disconnect a circuit between the shunt resistor and the comparator, respectively, when the detector circuit detects that the predetermined high voltage is applied;
a third low-pass filter inserted between the first switch element and the comparator; and
a fourth low-pass filter inserted between the second switch element and the comparator.

6. The charge and discharge control circuit as claimed in claim 1,
wherein the shunt resistor is inserted between the secondary battery and the charge control switch element, and
wherein the first voltage potential is applied to a power supply voltage terminal of the charge and discharge control circuit via the second low-pass filter.

7. The charge and discharge control circuit as claimed in claim 6,
wherein the first and second low-pass filters are provided as an inner circuit of the charge and discharge control circuit.

8. The charge and discharge control circuit as claimed in claim 6,
wherein the second low-pass filter is inserted between a negative electrode terminal of the secondary battery and a ground terminal of the charge and discharge control circuit, without any insertion between the second terminal of the shunt resistor and the comparator.

9. A protection circuit comprising:
a charge and discharge control circuit;
a charge control switch element; and
a discharge control switch element,
wherein the charge and discharge control circuit is configured to control the charge control switch element and the discharge control switch element,
wherein the charge control switch element is configured to control charge of a secondary battery,
wherein the discharge control switch element is connected in series with the charge control switch element, and is configured to control discharge of the secondary battery,
wherein the charge and discharge control circuit comprises:
a shunt resistor that is connected in series with the charge control switch element or the discharge control switch element and is connected between the secondary battery and a load, and is configured to detect a voltage corresponding to a discharge current or a charge current, and output first and second voltage potentials at a first terminal a nd a second terminal of the shunt resistor;
a comparator configured to compare the first voltage potential with a voltage potential of an addition voltage obtained by adding a predetermined threshold voltage to the second voltage potential, and output a comparison result signal indicating an overcurrent;
a logic circuit configured to control the charge control switch element or the discharge control switch element based on the comparison result signal;
a first low-pass filter inserted between the first terminal of the shunt resistor and the comparator; and
a second low-pass filter inserted between the second terminal of the shunt resistor and the comparator.

10. A battery pack comprising:
a secondary battery;
a charge and discharge control circuit;
a charge control switch element; and
a discharge control switch element,
wherein the charge and discharge control circuit is configured to control the charge control switch element and the discharge control switch element,
wherein the charge control switch element is configured to control charge of a secondary battery,
wherein the discharge control switch element is connected in series with the charge control switch element, and is configured to control discharge of the secondary battery,
wherein the charge and discharge control circuit comprises:
a shunt resistor that is connected in series with the charge control switch element or the discharge control switch element and is connected between the secondary battery and a load, and is configured to detect a voltage corresponding to a discharge current or a charge current, and output first and second voltage potentials at a first terminal a nd a second terminal of the shunt resistor;
a comparator configured to compare the first voltage potential with a voltage potential of an addition voltage obtained by adding a predetermined threshold voltage to the second voltage potential, and output a comparison result signal indicating an overcurrent;
a logic circuit configured to control the charge control switch element or the discharge control switch element based on the comparison result signal;
a first low-pass filter inserted between the first terminal of the shunt resistor and the comparator; and
a second low-pass filter inserted between the second terminal of the shunt resistor and the comparator.
